(19) United States
(12) Patent Application Publication
(10) Pub. No.: US 2011/0017850 A1
(43) Pub. Date: Jan. 27, 2011

(54) IRRIGATION METHOD, APPARATUS AND SYSTEM

(76) Inventor: Bert Waybright, Gettysburg, PA (US)

Correspondence Address: MAIER & MAIER, PLLC, 1000 DUKE STREET, ALEXANDRIA, VA, 22314, US

(21) Appl. No.: 12/509,606

(22) Filed: Jul. 27, 2009

(51) Int. Cl. B05B 3/00; A01G 25/09

(52) U.S. Cl. 239/728; 239/1

(57) ABSTRACT

A system, method and apparatus for providing irrigation. The system, method and apparatus may include a center pivot irrigation device. A moveable arm may be coupled to an end of the irrigation device.

### BACKGROUND

A variety of manners have been used to irrigate land. Currently, center pivot irrigation is a commonly used methodology. Center pivot irrigation typically involves a metallic structure that extends up to 500 meters in length and through which water is delivered. The structure rotates around a central pivot point, irrigating land in a circular area beneath the structure.

While the land beneath the structure is generally irrigated, there is typically a significant amount of land that is not irrigated by center pivot irrigation systems because fields are generally square in shape. For example, if a center pivot irrigation structure extends 400 meters from a center point, it can irrigate a circular area of about 126,600 m̂2. However, if a given field to be irrigated is generally square in shape and has sides of 400 m, it will have an area of about 160,000 m̂2. Therefore, approximately 33,400 m̂2 of land will not be irrigated by the center pivot irrigation system and that land may not be suitable for an activity, for example farming. Further, as most farms utilizing center pivot irrigation often have many different center pivot irrigation structures on their land, a significant amount of land may end up without proper irrigation, which may render it unsuitable for farming or growing crops.

### SUMMARY

An exemplary embodiment includes a method, system and apparatus for irrigation. One exemplary embodiment includes a center pivot irrigation device having a boom attached thereto; a moveable arm coupled to the boom with a hinge; a controller to control the moveable arm; and a fluid supply to provide fluid to the center pivot irrigation device, the boom and the moveable arm.

Another exemplary embodiment may include a method for irrigating an area. The method for irrigating can include rotating a center pivot irrigation boom in a circular fashion; providing fluid through the center pivot irrigation boom to irrigate an area below the center pivot irrigation boom; providing an adjustable arm at a distal end of the center pivot irrigation boom; lowering the arm at predetermined times; providing fluid through the arm to irrigate an area substantially below the arm; and raising the arm at predetermined times.

### BRIEF DESCRIPTION OF THE DRAWINGS

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary diagram showing a side perspective view of an irrigation system in a raised position.

FIG. 2 is an exemplary diagram showing an alternative side perspective view of an irrigation system in a lowered position.

FIG. 3 is an exemplary diagram showing yet another side perspective view of an irrigation system in a lowered position.

FIG. 4 is an exemplary diagram showing an end view of an irrigation system in a lowered position.

FIG. 5 is an exemplary diagram showing a side view of an irrigation system in a raised position.

FIG. 6 is an exemplary diagram showing an end view of an irrigation system in a raised position.

FIG. 7 is an exemplary diagram showing a side view of an irrigation system in a raised position.

FIG. 8 is an exemplary diagram showing a side view of an irrigation system in a lowered position.

FIG. 9 is an exemplary diagram showing an end view of an irrigation system in a lowered position.

FIG. 10 is an exemplary diagram showing an area that can be irrigated by an irrigation system.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

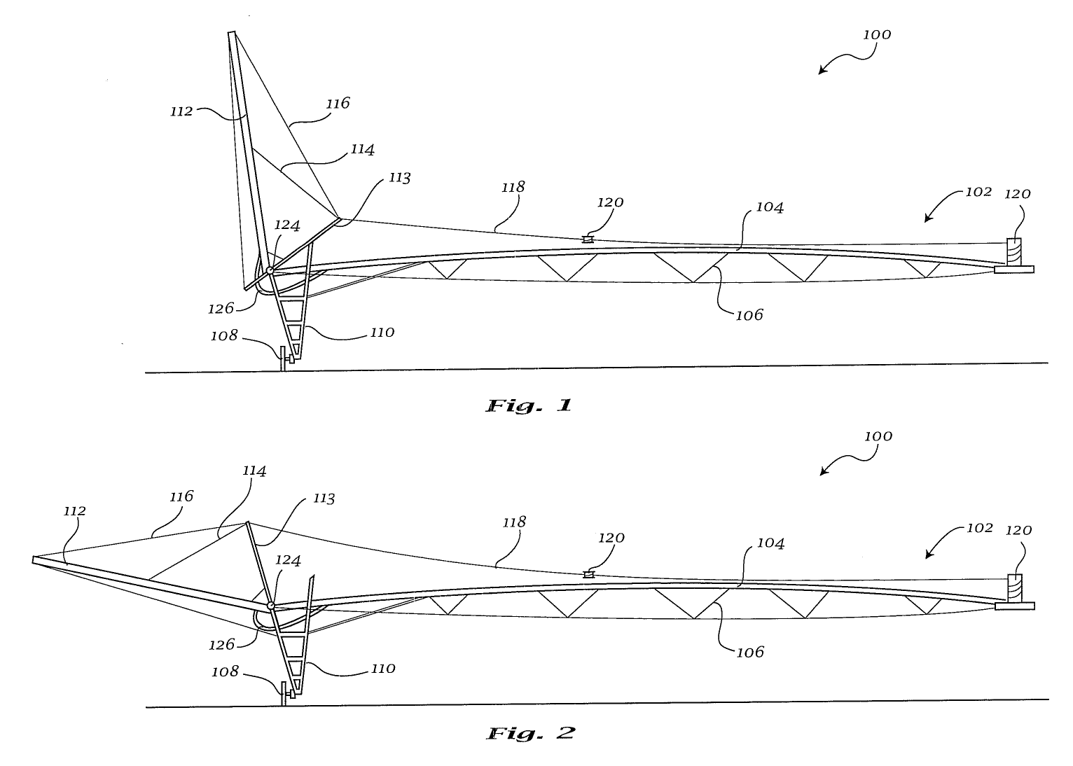

As shown generally in exemplary FIGS. 1-10, methods, systems and apparatuses for irrigation may be disclosed. One exemplary embodiment may include a center pivot irrigation system having an arm attached thereto. Another exemplary embodiment may include a variety of manners in which to store or stow an arm for a center pivot irrigation system when not in use. Still other exemplary embodiments may include manners in which to move an arm for a center pivot irrigation system.

One exemplary embodiment, as shown in FIG. 1, may include a center pivot irrigation system 100 with an arm attached thereto. The center pivot irrigation system 100 may be a center pivot irrigation system as is known in the art. For example, irrigation system 100 can include any number of, for example boom 102. Boom 102 may further include pipe segments, for example pipe segment 104, which may be supported by any number of trusses, for example truss 106. Further any portion of center pivot irrigation system, for example pipe segment 104 or truss 106, may be formed out of any material or materials, for example aluminum, galvanized steel and the like. Further, irrigation system may have water or any other fluid running there through. The fluid may be supplied by a fluid supply source located proximate a pivot point of the irrigation system 100. Additionally, irrigation system 100 may be any desired size and may deliver any desired amount of water or fluid. Further, pipe segment 104 or truss 106, and any other pipe segment or truss, may have any number of nozzles disposed therein. The nozzles can allow for a substantially uniform delivery of water or fluid, for example, by staggering nozzle size from smaller to larger as the distance from the fluid supply source.

Irrigation system 100 may further include mounting leg 110 onto which wheel 108 may be attached. Wheel 108 may be located at a distal end of boom 102 and may demarcate an outside perimeter of a circle where irrigation system 100 provides irrigation. Additionally, wheel 108 may have a motor attached thereto, or may be otherwise controlled, to allow for the movement of irrigation system 100 in a substantially circular manner. Any motor associated with wheel 108 or center pivot irrigation system 100 may be controlled in any manner known in the art.

In a further exemplary embodiment, center pivot irrigation system 102 may have an arm 112 attached at what may be a traditional distal end of the center point irrigation system 100. Arm 112 may be formed in a similar manner as other components of center point irrigation system 100, for example through the use of aluminum, galvanized steel and the like. Arm 112 may include any number of holes, similar to pipe segment 104 or truss 106. Additionally, as shown in FIG. 1, arm 112 may be folded up and down with respect to boom 102. In FIG. 1, arm 112 is positioned approximately perpendicular to boom 102. Arm 112 may be held in such a position through the use of cables 114 and 116, which may be connected to segment 113. Cables 114 and 116 may be connected to cable (or multitude of cables) 118. Cable 118 may be coupled with winch 120 and sheave or pulley 122, as well as to a motor which may be capable of actuating cable 118. Thus, in some exemplary embodiments, winch 120 may facilitate the pulling or relaxing of cable 118 through pulley 122, thus allowing for arm 112 to be raised or lowered to any desired position. For example, when arm 112 may not be in use, arm 112 may be positioned and locked in an upwards position; however, when arm 112 may be in use, arm 112 may be lowered into a position substantially in-line with pipe segment 104.

Arm 112 may include any of a variety of components that may allow for its use in irrigation. For example, hinge 124 may be located at or near a coupling point of arm 112 and boom 102. Hinge 124 may allow for the smooth movement of arm 112 from a raised position to a lowered position or a lowered position to a raised position. Additionally, hose 126 may be provided to allow for fluid, such as water, to be pumped from a central location to arm 112. Hose 126 may be any type of hose, for example a flexible hose. Additionally, 126 may be such that the flow of fluid therethrough is not affected by any movement of arm 112, for example movement of arm 112 from a raised position to a lowered position.

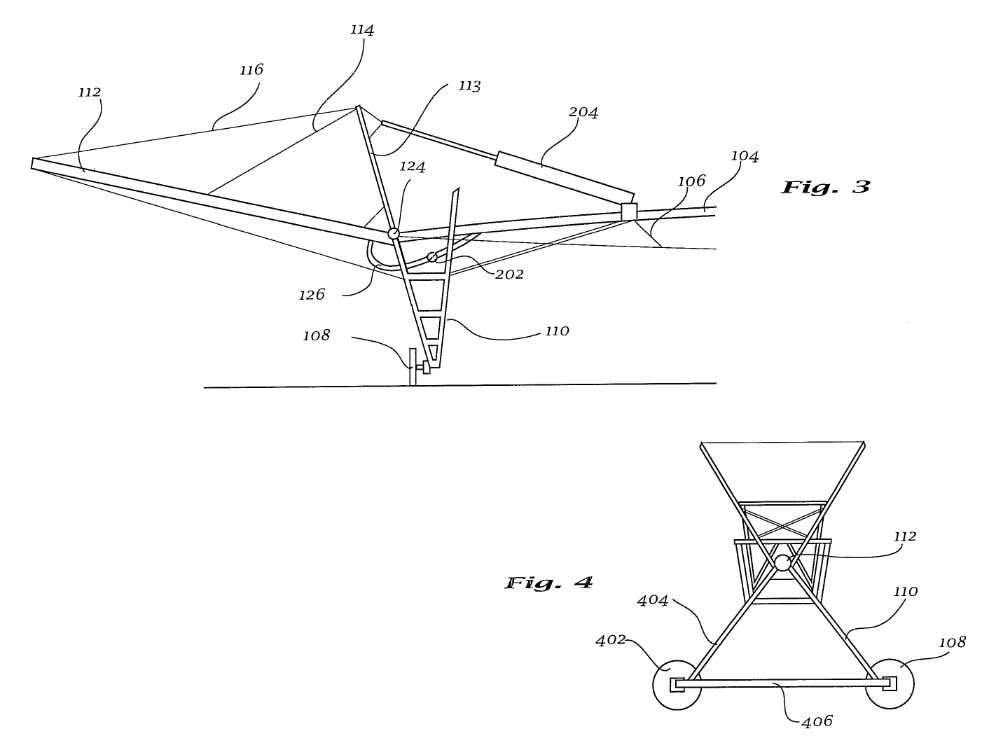

In a further exemplary embodiment, and as shown in the close-up view in FIG. 3, arm 112 may be hydraulically actuated. In this exemplary embodiment, hydraulic cylinder 204 may be disposed between a portion of irrigation system 102, for example pipe segment 104 or truss 106, and segment 113 of arm 112. Thus, at a desired time, hydraulic cylinder 204 may expand or contract, allowing for the lowering or raising of arm 112, respectively. Additionally, hydraulic cylinder 204, or any hydraulic actuation of arm 112 may be utilized in conjunction as an alternative to cable 118, winch 120 and pulley 122. However, in some other exemplary embodiments, hydraulic cylinder 204 may be used in conjunction with of cable 118 and any winch or motor attached thereto. Further, any actuation of arm 112 may be remotely controlled or automatically controlled. For example, if irrigation system 100 is positioned in a known location, any raising or lowering of arm 112 may be performed at any desired time or location, for example a predetermined time or location, such as the use of global positioning system (GPS) coordinates in an area to be irrigated.

Additionally, valve 202 may be disposed proximate arm 112, for example on hose 126. Valve 202 may be any type of valve that may be capable of regulating a flow of fluid therethrough. In some exemplary embodiments, valve 202 may be in an open position, allowing a flow of fluid therethrough, when arm 112 is in a lowered position, as shown in FIG. 3, an exemplary side view of an irrigation system, and FIG. 4, an exemplary end view of an irrigation system. As may be further seen in the side view of FIG. 4, wheel 402 may be connected to boom 102 through the use of leg 404. Additionally, wheel 108 may be coupled to wheel 402 through the use of connector 406. Further, any alternative number of wheels, legs and connectors may be used so as to provide any desired amount of support or stability to irrigation system 100.

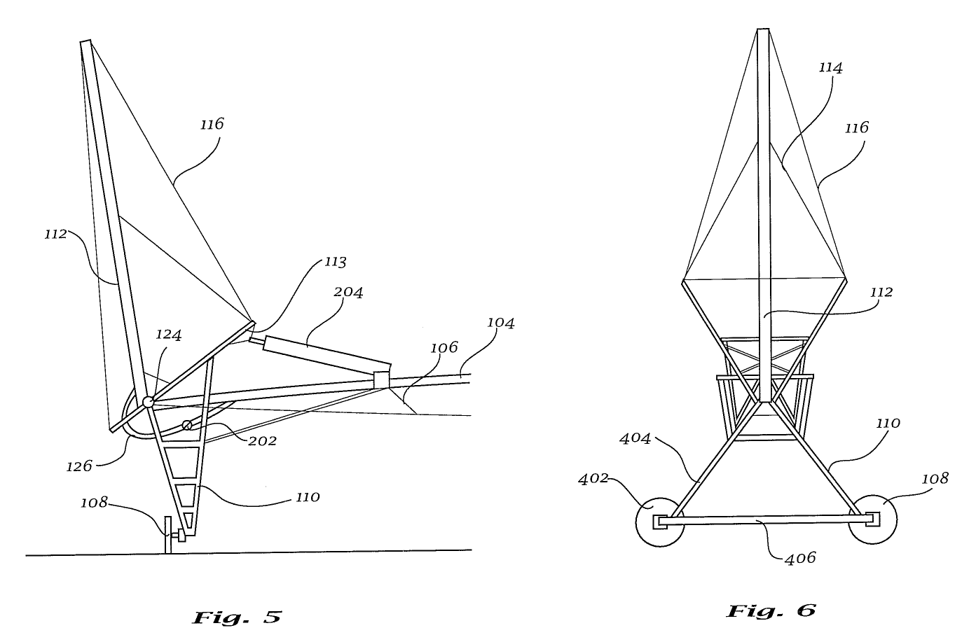

Similarly, FIG. 5 may show an exemplary side view of an irrigation system in a raised position, with hydraulic cylinder 204 contracted, and FIG. 6 may show an exemplary end view of an irrigation system in a raised position. In other exemplary embodiments, valve 202 may be in a closed position, preventing a flow of fluid therethrough, when arm 112 is in a raised position. In some further exemplary embodiments, valve 202, as well as any other component on irrigation system 102, may be remotely controlled or actuated. Valve 202 may be such that it may be actuated electronically or mechanically by a remotely-located controller. For example, a remotely-located computer may have information regarding one or more desired times to raise or lower arm 112 and to open or close valve 202. Thus, a remotely-located computer can send a signal to an actuator that can open or close valve 202, or vary the amount of fluid flowing through valve 202 in any desired fashion.

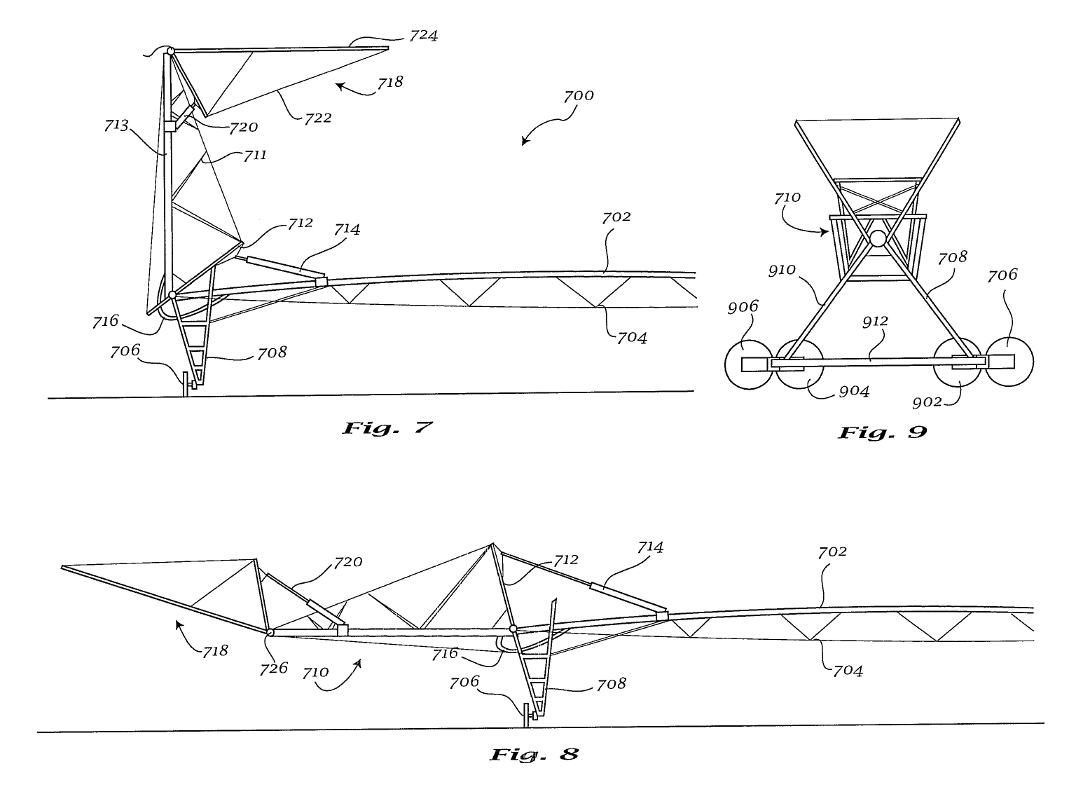

In yet another exemplary embodiment, and as shown in FIGS. 7-9, an irrigation system may include multiple portions that may be raised or lowered. In exemplary FIG. 7, a center pivot irrigation system boom 700 may be seen. Irrigation system boom 700 (as well as other aspects of a center pivot irrigation system) may have many of the same components as that shown with respect to previously discussed irrigation systems, for example pipe segment 702, truss 704, wheel 706 and leg 708. Additionally, similar to previous examples, arm 710 may be connected to an end portion of boom 700. Further, hydraulic cylinder 714 may be connected to segment 712, for example to truss 711, and boom 700 to allow for actuation of arm 710. Alternatively, any other desired method of actuating arm 710 may be used. Also, as in previously discussed embodiments, arm 710 may be coupled to hose 716, which may supply fluid to arm 710, as well as any other desired components, for example through pipe segment 713, which may be used for irrigation.

Arm 710 may further be connected to arm 718. Arm 718 may be a segment substantially similar to arm 710, such as having truss 722 and pipe segment 724, and may be coupled to arm 710 in a manner that is similar to how arm 710 is coupled to irrigation system 700, for example using hinge 726. Further, arm 718 may be supplied with any desired fluid in any desired amount, and may be actuated in any desired manner, for example through the use of hydraulic cylinder 720, which may be connected to arm 713 or truss 711 or arm 710. Arm 718 may be stored in any position when not in use, for example substantially parallel to irrigation system 700 and substantially perpendicular to arm 710. However, arm 718 may be stored in any desired position, for example substantially parallel to arm 710.

Arm 718 may, in some further exemplary embodiments, be removably coupled to arm 710 so as to allow for an irrigation system 700 to extend further, when or if desired. For example, if further irrigation is desired, arm 710 may be moved to a lowered position and fluid may be supplied thereto. Similarly, arm 718 may be lowered to a position where it is substantially in line with arm 710 and irrigation 700 and fluid may be delivered thereto, providing for any desired extra length of irrigation as desired. In some further exemplary embodiments, if it is not desired to use arm 718 but it may still be desired to use arm 710, arm 718 may be raised to a position substantially perpendicular to the arm 710. Further if it is not desired to use either arm 710 or arm 718, both arms may be raised to substantially the position shown in FIG. 7, or any other desired position.

Additionally, exemplary views of an irrigation system 700 with arms 710 and 718 in a lowered position are shown in the side view of FIG. 8 and the end view of FIG. 9. These views are exemplary, however, and arms 710 and 718 may be utilized at any position relative to irrigation system 700. For example, arm 710 may be substantially in line with pipe segment 702 and arm 718 may angled substantially upwards from arm 710. As shown in exemplary FIG. 8, hydraulic cylinder 712 may be in an expanded position, thus lowering arm 710 to a desired level. Further, hydraulic cylinder 720 may also be in an expanded position, thus lowering arm 718 to a desired position. However, arms 710 and 718 may be positioned at any level or angle so as to provide for a desired amount of irrigation.

Additionally, in exemplary FIG. 9, additional components which may be used in an irrigation system may be shown. For example wheel 902 may be substantially coupled to wheel 706 and wheels 904 and 906 may be coupled together so as to allow for movement of the irrigation system. Additionally, similar to leg 708, leg 910 may couple wheels 904 and 906 to boom 700. Also, connector 912 may be used to couple wheels 706 and 902 to wheels 904 and 906, for example to provide stability to the irrigation system.

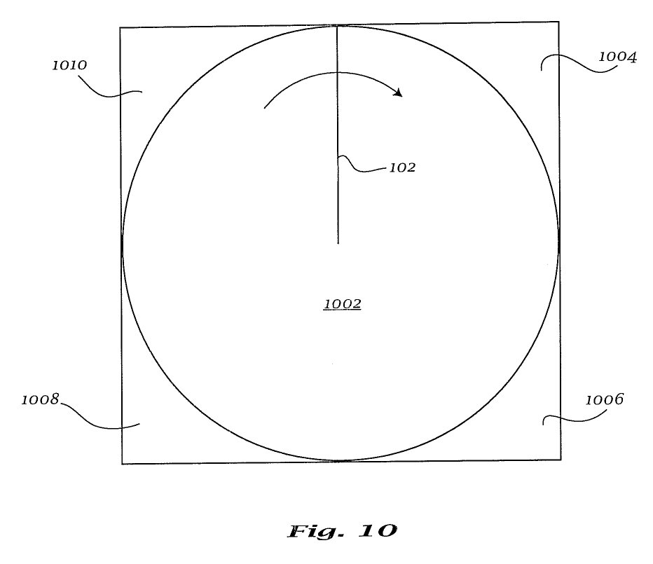

In another exemplary embodiment, a method of irrigating may be disclosed. The method of irrigating may incorporate a center pivot irrigation system, for example center pivot irrigation system 100, as shown in FIGS. 1-5. Irrigation system 100 may have one or more adjustable arms attached thereto, for example arm 112. As irrigation system 100 is rotated in a field, a substantially circular area may be irrigated, such as area 1000 of exemplary FIG. 10. However, other areas which may be viable land where it may be desired to irrigate may be irrigated through the use of one or more retractable arms, for example arm 112. Thus, in one exemplary embodiment, as irrigation system 102 is rotating and irrigating area 1002, an arm may be used to irrigate outlying areas, for example areas 1004, 1006, 1008 and 1010.

In some exemplary embodiments, irrigation system 100 may be controlled in any desired manner, for example receiving computer instruction to rotate at predetermined times to provide a desired amount of irrigation to a desired area. Thus, in a further exemplary embodiment, arm 112 of irrigation system 100 may also be controlled so as to provide irrigation to a desired area. Assuming in this example that irrigation system 100 is rotating clockwise over area 1002 in FIG. 10, arm 112 may be lowered to provide irrigation to areas 1004, 1006, 1008 and 1010. For example as irrigation system 100 is rotating and irrigation a top-center portion of area 1002, arm 112 may be in a raised position. However, as irrigation system 100 rotates to the top-right portion of area 1002, area 1004 may not be irrigated. Thus, arm 112 may be lowered to provide irrigation to this area. For example, arm 112 may be lowered partially and fluid, such as water, may be provided throughout arm 112 so that area 1004 is irrigated. Then, as area 1004 becomes larger, arm 112 may be lowered into a position that allows for the maximum coverage of irrigation and the irrigation may be provided through arm 112. Then, as area 1004 becomes smaller, arm 112 may be raised to so as to provide correspondingly less irrigation as the amount of desired irrigation area in area 1004 becomes smaller. Finally, arm 112 may be in a fully raised position and any fluid flowing therethrough to provide irrigation may be shut off, for example preventing the unnecessary irrigation of a piece of land that may be otherwise irrigated or that may not be desired to be irrigated. In a further exemplary embodiment, the arm 112 may allow for a substantially square portion of land to be irrigated that would not otherwise be irrigated by a center pivot irrigation system.

In a similar exemplary embodiment, an irrigation system having two or more moveable or retractable arms may be used to irrigate an area such as area 1002 in FIG. 10. For example, the irrigation system shown in exemplary FIGS. 7-9 may be used to provide irrigation to different areas, for example areas out of reach of a standard center pivot irrigation system.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An irrigation apparatus, comprising:
a center pivot irrigation device having a boom attached thereto;
a moveable arm coupled to the boom with a hinge;
a controller to control the moveable arm; and
a fluid supply to provide fluid to the center pivot irrigation device, the boom and the moveable arm.

2. The irrigation apparatus of claim 1, further comprising a hydraulic cylinder that raises and lowers the arm.

3. The irrigation apparatus of claim 1, further comprising a remotely located controller that raises and lowers the arm at predetermined times.

4. The irrigation apparatus of claim 1, further comprising a valve that regulates fluid flow from the center pivot irrigation boom to the arm.

5. The irrigation apparatus of claim 1, further comprising one or more pulleys and one or more cables to move the arm.

6. The irrigation apparatus of claim 1, wherein the arm is lowered and fluid is supplied to the arm when the center pivot irrigation boom pivots to an area where the center pivot irrigation boom can not provide irrigation.

7. A method of irrigating an area, comprising:
rotating a center pivot irrigation boom in a circular fashion;
providing fluid through the center pivot irrigation boom to irrigate an area below the center pivot irrigation boom;
providing an adjustable arm at a distal end of the center pivot irrigation boom;
lowering the arm at predetermined times;
providing fluid through the arm to irrigate an area substantially below the arm: and
raising the arm at predetermined times.

8. The method of claim 7, further comprising providing fluid through the arm while it is being lowered.

9. The method of claim 7, further comprising providing fluid through the arm while it is being raised.

10. The method of claim 9, wherein the arm is raised and the arm is lowered by a remotely located controller.
